(19) United States
(12) Patent Application Publication
(10) Pub. No.: US 2024/0244454 A1
(43) Pub. Date: Jul. 18, 2024

(54) MACHINE LEARNING MODEL CONFIGURATION FOR REDUCED CAPABILITY USER EQUIPMENT

(71) Applicant: QUALCOMM Incorporated, San Diego, CA (US)

(72) Inventors: Huilin XU, Temecula, CA (US); June NAMGOONG, San Diego, CA (US); Yuwei REN, Beijing (CN); Fei HUANG, San Diego, CA (US); Duo ZHANG, San Diego, CA (US)

(21) Appl. No.: 18/561,814

(22) PCT Filed: Jul. 27, 2021
(86) PCT No.: PCT/CN2021/108576

§ 371 Date: Nov. 17, 2023

(51) Int. Cl. H04W 24/02; H04L 1/00; H04W 72/1273; H04W 72/231

(52) U.S. Cl. CPC H04W 24/02; H04L 1/0061; H04W 72/1273; H04W 72/231

(57) ABSTRACT

Certain aspects of the present disclosure provide techniques for configuring machine learning models on user equipment, including reduced capability user equipment.

### INTRODUCTION

Aspects of the present disclosure relate to wireless communications, and more particularly, to techniques for machine learning model configuration for reduced capability user equipment.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

In one aspect, a method includes receiving, at a user equipment from a network, control information, wherein the control information indicates a first configuration for receiving a first type of machine learning model and a second configuration for receiving a second type of machine learning model, the first type of machine learning model is configured for a first type of user equipment, and the second type of machine learning model is configured for a second type of user equipment; determining to apply at least one of the first configuration or the second configuration based on whether the user equipment is the first type of user equipment or the second type of user equipment; and receiving a first machine learning model from the network according to at least one of the first configuration or the second configuration based on the determining.

In another aspect, a method includes receiving, at a user equipment from a network, control information, wherein the control information indicates a configuration for receiving a type of machine learning model, the type of machine learning model is configured for a type of user equipment, and the control information includes a CRC scrambled via a user equipment group-specific RNTI associated with the type of user equipment; and receiving a machine learning model from the network according to the configuration, wherein the user equipment is the type of user equipment.

In another aspect, a method includes receiving, at a user equipment from a network, a configuration for a first type of machine learning model; receiving, at the user equipment from the network, a configuration for a second type of machine learning model; configuring a machine learning model on the user equipment based on at least one of the configuration for the first type of machine learning model or the configuration for the second type of machine learning model and based on a type of the user equipment; and performing an operation with the machine learning model.

In another aspect, a method includes transmitting, from a network to a user equipment, control information, wherein the control information indicates a first configuration for receiving a first type of machine learning model and a second configuration for receiving a second type of machine learning model, the first type of machine learning model is configured for a first type of user equipment, and the second type of machine learning model is configured for a second type of user equipment; transmitting a first machine learning model of the first type according to the first configuration; and transmitting a second machine learning model of the second type according to the second configuration.

In another aspect, a method includes transmitting, from a network to a user equipment, control information, wherein the control information indicates a configuration for receiving a type of machine learning model, the type of machine learning model is configured for a type of user equipment, and the control information includes a CRC scrambled via a user equipment group-specific RNTI associated with the type of user equipment; and transmitting a machine learning model to the user equipment according to the configuration, wherein the user equipment is the type of user equipment.

In another aspect, a method includes transmitting, from a network to a user equipment, a configuration for a first type of machine learning model; and transmitting, from the network to the user equipment, a configuration for a second type of machine learning model, wherein the first type of machine learning model results in a lower complexity machine learning operation than the second type of machine learning model.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4A depicts an example call flow diagram 400 related to configuring machine learning models on devices of different types.

FIG. 4B depicts another example call flow diagram 450 related to configuring machine learning models on devices of different types.

FIG. 5 depicts another example call flow diagram 500 related to configuring machine learning models on devices of different types.

FIGS. 6 through 11 show example methods for machine learning model configuration for reduced capability user equipment according to aspects of the present disclosure.

FIGS. 12 through 13 show examples of a communications device according to aspects of the present disclosure.

### DETAILED DESCRIPTION

Aspects of the present disclosure provide apparatuses, methods, processing systems, and computer-readable mediums for machine learning model configuration for reduced capability user equipment.

As networks are becoming more capable and data services more diversified, there is a need to further segment and control user equipment configurations based on user equipment capabilities.

For example, a type (or category) of user equipment referred to as “reduced capability” (or “redcap”) user equipment may have fewer antennas, narrower bandwidth, and longer processing timelines as compared with “regular capability” (or “regcap”) user equipment. Some example use cases for reduced capability user equipment may include metering devices, asset tracking devices, personal Internet of things (IoT) devices, sensor devices, and the like.

In order for a network to keep track of capabilities of user equipment accessing the network, user equipment capabilities may be associated with or part of a network subscriber's profile data, which may include subscription data defining network accesses and services available to the subscriber. In some cases, user equipment capability categories, including specific categories for reduced capability user equipment, may be defined in network interoperability standards, such as those maintained by 3GPP. Such categories can be based on various factors, such as expected use case (e.g. wearables, camera, sensors, internet of things (IoT), etc.), as well as based on user equipment's radio capabilities (e.g. high performance, mid-tier, low cost, etc.), and combinations these and other characteristics. In some cases, network operators may adopt all or some subset of the categories defined by standards, or define their own user equipment categories based on operational needs specific to their network environments and users. Notably, these are just a few examples, and many others are possible.

Machine learning for wireless communications is becoming increasingly prevalent and is considered a powerful technique for many wireless communication tasks, such as channel state feedback (CSF), positioning, channel estimation, and others. Compared to conventional methods, machine learning (e.g., through the power of deep neural networks) can provide huge performance improvement at the cost of increased computational complexity. Generally speaking, different machine learning models may be configured for different applications as well as the same application. Regarding the latter case, machine learning models may be optimized for different scenarios and/or have different levels of complexity. For example, one baseline model may be configured to support both indoor and outdoor positioning, and more specific models may be configured to support indoor positioning, or outdoor positioning, but not both.

Various problems may arise when a network tries to configure user equipment of varying capabilities to use machine learning techniques. For example, as the use of machine learning and machine learning models becomes a more predominant feature in user equipment functionality, it becomes important to account for what types of user equipment (e.g., regular capability versus reduced capability) can implement what machine learning tasks and models. Whereas regular capability user equipment may be able to perform local training, and participate in federated learning, reduced capability user equipment may not be able to perform such tasks owing to processing power, memory, and/or battery power considerations, to name a few. Consequently, a network should not dedicate finite physical resources (e.g., wireless resources) to configuring user equipment with machine learning models and machine learning tasks (e.g., training and inferencing) that such user equipment cannot actually exploit or perform. In particular, because machine learning models may have a huge number of parameters, configuring models on user equipment unnecessarily results in huge network signaling overhead.

Accordingly, aspects described herein provide methods for configuring machine learning models for user equipment of varying capabilities (e.g., regular capability and reduced capability) without wasting network resources.

In various aspects, a network may transmit control information indicating different messages comprising different machine learning model configurations for different user equipment capabilities (e.g., regular capability user equipment reduced capability user equipment). Once a user equipment of a particular capability level receives the control information, it may only receive a model configuration messages for its own user equipment type and capability level, and skip receipt of model configuration messages inapplicable to its own user equipment type and capability level.

In various aspects, a user equipment of a relatively higher capability level (e.g., a regular capability user equipment) may also receive and utilize model configurations configured for relatively lower capability user equipment (e.g., reduced capability user equipment). Then, such user equipment may have multiple model configurations that require different levels of complexity that can be exploited based on other considerations. For example, such a user equipment may be configured to switch between the multiple model configurations for better power consumption performance when other performance requirements can be relaxed in certain conditions, such as for positioning in low mobility, channel and channel state feedback accuracy for low traffic duty cycle, high signal-to-noise ratio conditions, etc.

In various aspects, a network may transmits machine learning model configuration in messages that are only detectable by specific types of user equipment. For example, a network may transmit a configuration message for a more complex machine learning model in such a way that only a regular capability user equipment can receive the configuration message. Similarly, the network may transmit a configuration message for a less complex machine learning model in such a way that only a reduced capability user equipment can receive the configuration message. For example, regular capability user equipment and reduced capability user equipment may be configured with different group common radio network temporary identifier (RNTIs) to receive scheduled model configuration messages.

In various aspects, a network may configure a machine learning model for multiple types of user equipment (e.g., for regular capability user equipment and reduced capability user equipment) in the same message. The configured model may be directly used by regular capability user equipment, while additional configuration may be provided by the network (e.g., within the original message or in a separate message) for a reduced capability user equipment. The additional configuration may indicate, for example, parameters of a part or portion of a machine learning model (e.g., early, mid and/or late layers of a neural network model) that are updated during model training and/or used by the machine learning model during inferencing. Beneficially then, the additional configuration may reduce computational complexity for model training and inferencing for reduced capability user equipment without needing to maintain multiple separate models.

In some aspects, the additional configuration may indicate that part of the machine learning model is to be replaced by other algorithms (e.g., lower complexity conventional algorithms). This type of additional configuration may likewise reduce computational complexity for both model training and inference. For example, early layers of a neural network may be used to generate features that are then used as input to conventional algorithms, such as support vector machines, k-nearest neighbors, and other algorithms. Generally, this type-specific configuration of a single base model for multiple user equipment types can significantly reduce signaling overhead for the network during over the air model configuration.

In various aspects, model configurations may be cell-specific, user equipment group-specific, user equipment model-specific, or even individual user equipment-specific. Other groupings are possible.

Note that while two categories of user equipment (regular capability user equipment and reduced capability user equipment) are described in various examples herein for simplicity, further categorization, delineation, etc. is possible. For example, there may be a range of capability groups that are defined and for which specific machine learning model confirmations may be configured by a network.

### Introduction to Wireless Communication Networks

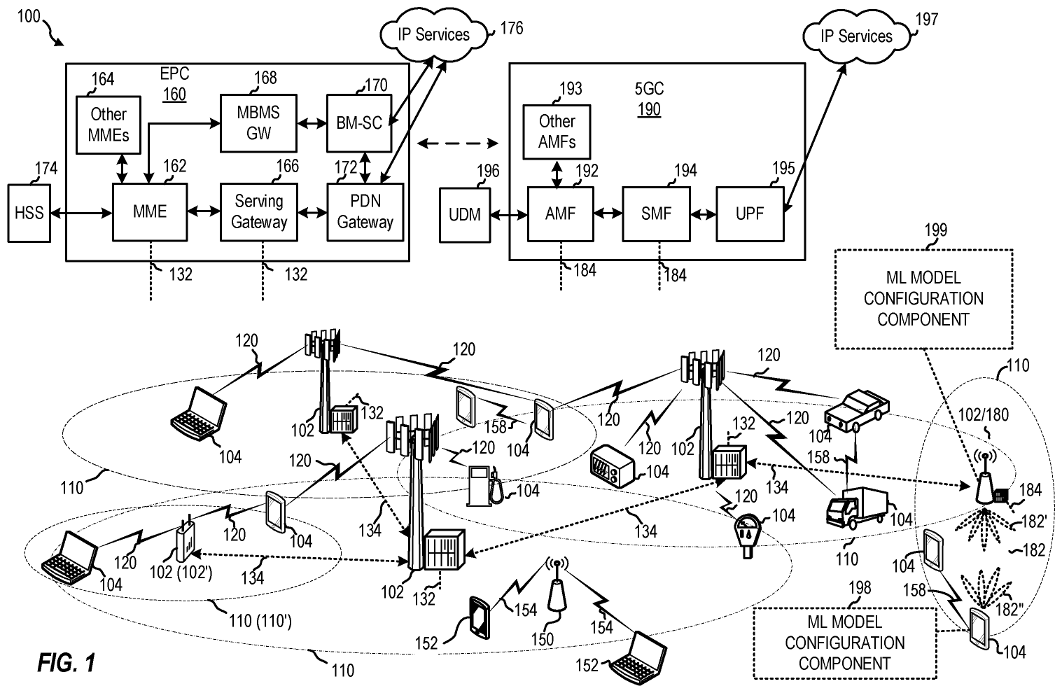

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes machine learning model configuration 199, which may be configured to configure machine learning models on a user equipment connected to the network (e.g., through various signaling sent by the network 100, as described herein). Wireless network 100 further includes machine learning model configuration 198, which may be used configured to configure machine learning models on a user equipment (e.g., based on various signaling receoved from the network 100, as described herein).

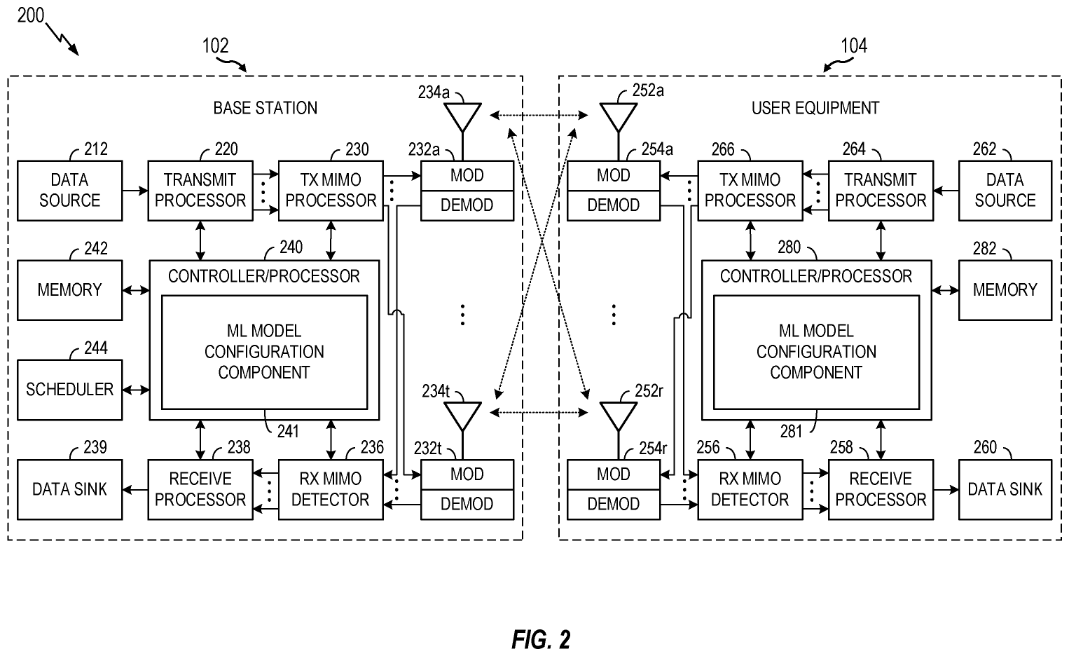

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes machine learning model configuration 241, which may be representative of machine learning model configuration 199 of FIG. 1. Notably, while depicted as an aspect of controller/processor 240, machine learning model configuration 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes machine learning model configuration 281, which may be representative of machine learning model configuration 198 of FIG. 1. Notably, while depicted as an aspect of controller/processor 280, machine learning model configuration 281 may be implemented additionally or alternatively in various other aspects of user equipment 104 in other implementations.

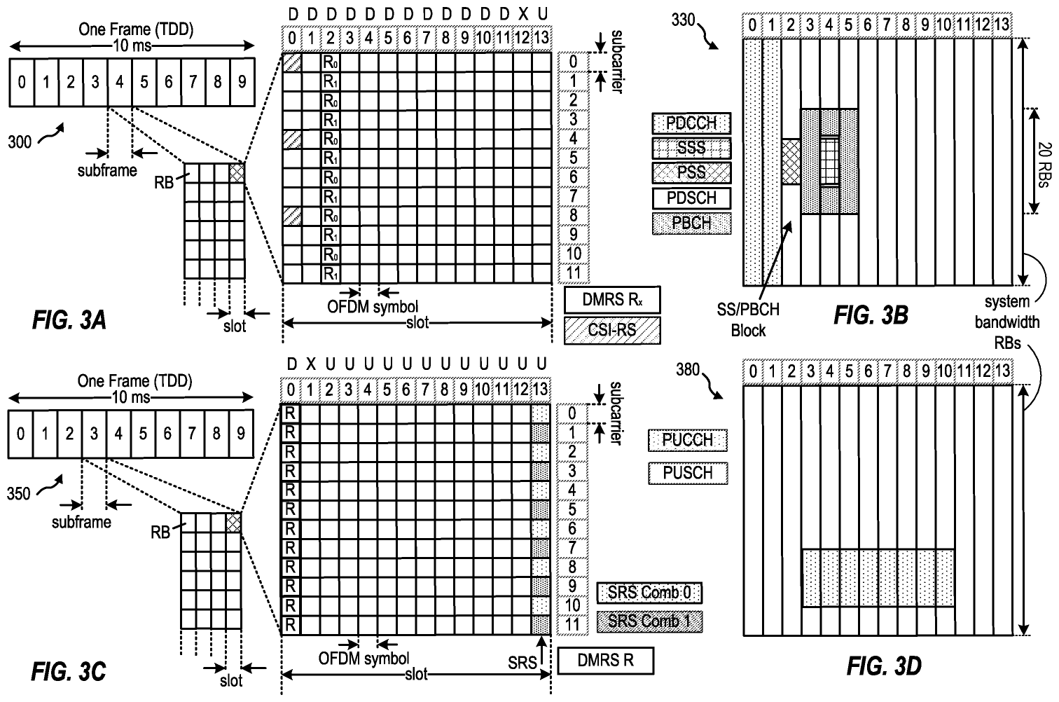

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Aspects Related to Machine Learning Model Configuration for Reduced Capability User Equipment

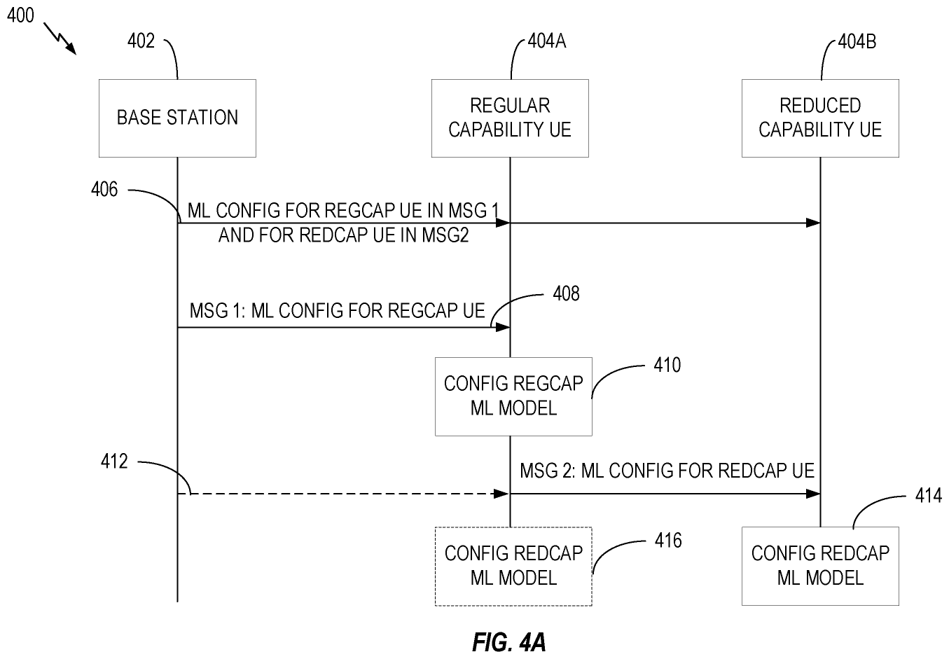

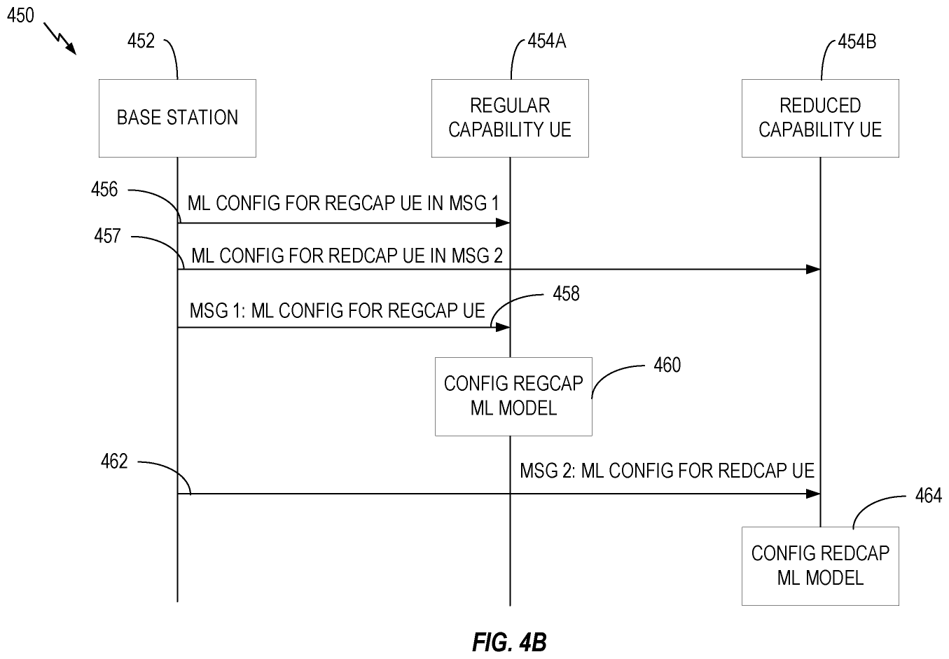

FIG. 4A depicts an example call flow diagram 400 related to configuring machine learning models on devices of different types.

In particular, at step 406, base station 402 (which may be an example of a network entity, such as base station 102 in FIGS. 1 and 2), transmits a message to regular capability user equipment 404A (which may be an example of user equipment 104 in FIGS. 1 and 2) including control information for receiving model configuration data. In this example, the control information includes information regarding scheduled messages (MSG 1 and MSG 2) with user equipment type-specific (e.g., regular capability and reduced capability) machine learning model configurations. Further in this example, the message transmitted at step 406 is receivable by both user equipment 404A and 404B, despite these user equipment being of different type (one regular capability, 404A, and one reduced capability, 404B).

The message transmitted at step 406 may be transmitted in different types of network communication, including downlink control information (DCI), radio resource control (RRC) messaging, medium access control (MAC) control element (CE), system information blocks (SIBs), and the like. Since this control information should be received by both types of user equipments, it will generally not be carried by unicast or UE specific signaling.

For example, the control information can include DCI in a physical downlink control channel (PDCCH). In some cases, the DCI can be CRC scrambled by a cell-specific or UE group common RNTI that is configured for both types of user equipments, which in this example include regular capability user equipment 404A and reduced capability user equipment 404B.

As a further example, the control information can include a MAC CE command, an RRC message or a SIB, all of which may be scheduled by DCI in a PDCCH. This DCI, as above, can be CRC scrambled by a cell specific or UE group common RNTI that is configured to both types of user equipments.

In some aspects, the control information may include a bitmap, a codepoint, or similar to indicate whether the machine learning model configuration for a user equipment type (e.g., regular capability or reduced capability) is provided in a configured occasion of machine learning model configuration messages (e.g., the next configured occasion).

Continuing to step 408, base station 402 transmits MSG 1 including a machine learning model configuration (e.g., a set of parameters including weights, biases, model architecture, hyperparameters, and the like) for a regular capability user equipment. This message may be transmitted, for example, on a physical downlink shared channel (PDSCH).

At step 410, regular capability user equipment 404A receives MSG 1 and configures a machine learning model in accordance with the information in MSG 1. In some cases, the machine learning model configuration may additionally include information on how and when to use the machine learning model, what sort of input data to provide to the machine learning model, what sort of output data is generated by the machine learning model, how to use that output data for another task (e.g., channel estimation), etc. Here, regular capability user equipment 404A knows when to become active and receive MSG 1 based on the control information received from base station 402 at step 406.

Continuing to step 412, base station 402 transmits MSG 2 including another machine learning model configuration for a reduced capability user equipment.

At step 414, reduced capability user equipment 404B receives MSG 2 and configures a machine learning model in accordance with the information in MSG 2. Here again, reduced capability user equipment 404A knows when to become active and receive MSG 2 based on the control information received from base station 402 at step 406.

Optionally, at step 416, regular capability user equipment 402A receives MSG 2 and configures a machine learning model in accordance with the information in MSG 2. As described above, in some cases, regular capability user equipment 404A may be configured to use both models depending on different conditions. For example, regular capability user equipment 404A may consider one or more operating conditions to decide when to deploy the higher complexity or lower complexity models, including: a battery state of the user equipment; a power state of the user equipment; a radio resource control (RRC) state of the user equipment; an active bandwidth part of the user equipment; a condition of a channel between the user equipment and the network; or a mobility state of the user equipment. Note that these are just a few examples, and generally any condition monitored or otherwise known by regular capability user equipment 404A may be used in logic for deciding which of a plurality of machine learning models configured by the network to use at a given time and for a given task.

FIG. 4B depicts another example call flow diagram 450 related to configuring machine learning models on devices of different types.

In particular, at step 456, base station 452 (which may be an example of a network entity, such as base station 102 in FIGS. 1 and 2), transmits a message to regular capability user equipment 454A (which may be an example of user equipment 104 in FIGS. 1 and 2) including control information for receiving model configuration data. In this example, the control information includes information regarding a scheduled message MSG 1, which itself contains user equipment type-specific (e.g., regular capability user equipment) machine learning model configuration data. Unlike the example in FIG. 4A, here the message transmitted at step 406 is receivable by only regular capability user equipment, including user equipment 404A.

For example, step 456 may include sending DCI that is CRC scrambled by user equipment group common RNTI configured for the type of user equipment that expects to receive the machine learning model configuration, which in this case is regular capability user equipment 454A. Thus, in this example, regular capability user equipment 454A and reduced capability user equipment 454B may be configured with different group common RNTIs to receive the associated scheduling DCIs and the scheduled model configuration message.

The message transmitted at step 456 may be transmitted in different types of network communication, as above, including downlink control information (DCI), radio resource control (RRC) messaging, medium access control (MAC) control element (CE) command, system information blocks (SIBs), and the like. For example, the control information can include DCI in a physical downlink control channel (PDCCH). As a further example, the control information can include a MAC CE command, an RRC message or a SIB, all of which may be scheduled by DCI in a PDCCH.

Continuing to step 457, base station 452 transmits a message to reduced capability user equipment 454B including control information for receiving model configuration data. In this example, the control information includes information regarding a scheduled message MSG 2, which itself contains user equipment type-specific (e.g., reduced capability user equipment) machine learning model configuration data. Here again, MSG 2 is configured to be receivable by only reduced capability user equipment, including user equipment 454B.

Continuing to step 458, base station 452 transmits MSG 1 including a machine learning model configuration (e.g., a set of parameters including weights, biases, model architecture, hyperparameters, and the like) for a regular capability user equipment.

At step 460, regular capability user equipment 454A receives MSG 1 and configures a machine learning model in accordance with the information in MSG 1. Here, regular capability user equipment 454A knows when to become active and receive MSG 1 based on the control information received from base station 452 at step 456.

Continuing to step 462, base station 452 transmits MSG 2 including another machine learning model configuration for a reduced capability user equipment.

At step 464, reduced capability user equipment 454B receives MSG 2 and configures a machine learning model in accordance with the information in MSG 2. Here again, reduced capability user equipment 454A knows when to become active and receive MSG 2 based on the control information received from base station 452 at step 457.

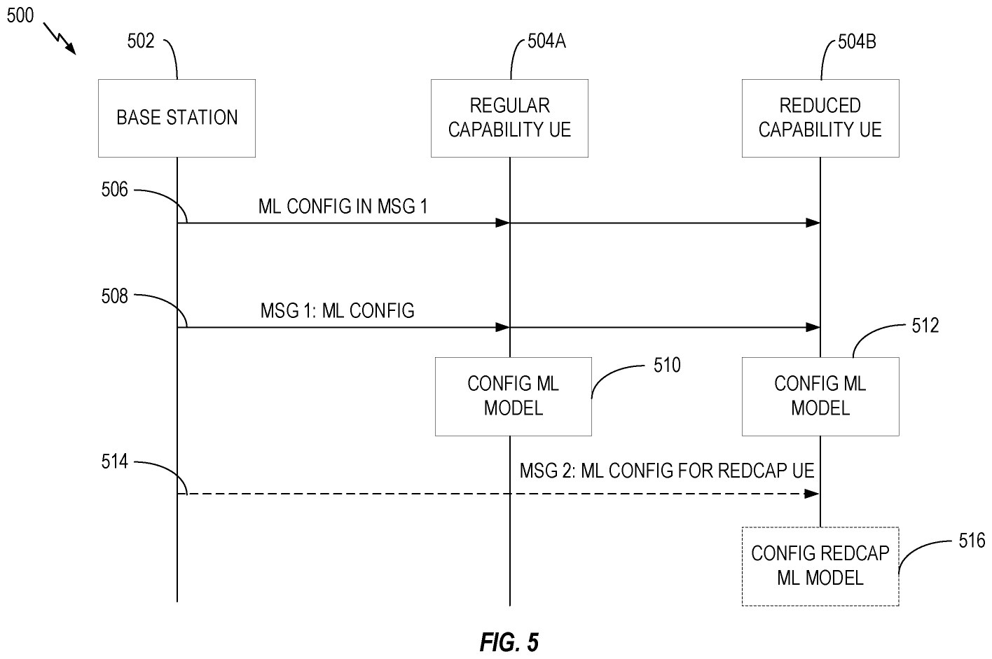

FIG. 5 depicts another example call flow diagram 500 related to configuring machine learning models on devices of different types.

In some cases, it may be desirable for the network to configure machine learning models at different types of user equipment at the same time. Generally, the configured model may be directly used by a regular capability user equipment (e.g., 504A), but require further configuration to be usable by a different type of user equipment (e.g., reduced capability user equipment 504B).

As depicted, base station 502 may send a message at step 506 comprising control information for receiving a machine learning model configuration in MSG 1. Unlike in FIGS. 4A and 4B, in this example, a single message schedules both types of user equipment to receive a common machine learning model configuration.

At 508, base station 502 then sends the machine learning model configuration in MSG 1 to both regular capability user equipment 504A and reduced capability user equipment 504B.

In some cases, the machine learning model configuration sent in MSG 1 at step 508 may configure a model that is usable by both regular capability user equipment 504A and reduced capability user equipment 504B. For example, the machine learning model may be one that is less complex and thus capable of being processed by reduced capability user equipment 504B. Thus, at steps 510 and 512, regular capability user equipment 504A and reduced capability user equipment 504B can configure the machine learning model.

In other cases, the machine learning model configuration sent in MSG 1 at step 508 may configure a model that is initially usable only by regular capability user equipment 504A and not reduced capability user equipment 504B. For example, the machine learning model may be one that is more complex and thus not capable of being processed by reduced capability user equipment 504B in its initial configuration. In such cases, base station 502 may optionally send an additional (or supplemental) model configuration at step 514 in MSG 2 to modify the initial model configuration for use by a less powerful user equipment, such as reduced capability user equipment 504B. In some examples, the control information for receiving MSG 2 is sent in the message sent at step 506. In other cases (not depicted), it may be sent in a separate scheduling message.

In some aspects, the additional configuration in MSG 2 may indicate, for example, parameters of a part or portion of a machine learning model (e.g., early, mid and/or late layers of a neural network model) that are updated during model training and/or used by the machine learning model during inferencing. In other words, the additional configuration may cause a subset of the full model to be used during training and/or inferencing rather than the whole model. Beneficially then, the additional configuration may reduce computational complexity for model training and inferencing for reduced capability user equipment without needing to maintain multiple separate models.

In some aspects, the additional configuration in MSG 2 may also or alternatively indicate that part of the machine learning model is to be replaced by other algorithms (e.g., lower complexity conventional algorithms). This type of additional configuration may likewise reduce computational complexity for both model training and inference. For example, early layers of a neural network may be used to generate features that are then used as input to conventional algorithms, such as support vector machines, k-nearest neighbors, and other algorithms. Generally, this type-specific configuration of a single base model for multiple user equipment types can significantly reduce signaling overhead for the network during over the air model configuration.

Thus, at step 516, reduced capability user equipment 504B may optionally configure a reduced complexity version of the model based on the additional configuration data in MSG 2.

In an alternative example, base station 502 may send both the base model configuration (suable by regular capability user equipment 504A) as well as the additional configuration to modify the model to be usable by reduced capability user equipment 504B within MSG 1 at step 506. This beneficially reduces the need for further scheduled messages (such as 514), but does slightly increase the overhead for regular capability user equipment (e.g., 504A) when receiving MSG 1 (since the additional configuration information is not necessarily needed by regular capability user equipment 504A). However, in such examples, regular capability user equipment 504A then has the option of configuring the lower complexity machine learning model, which can be used based on various operational conditions, as described above.

Beneficially, the scheme depicted in FIG. 5 can significantly reduce signaling overhead for model configuration for multiple types of user equipment.

### Example Methods of Configuring Machine Learning Models on Reduced Capability User Equipment

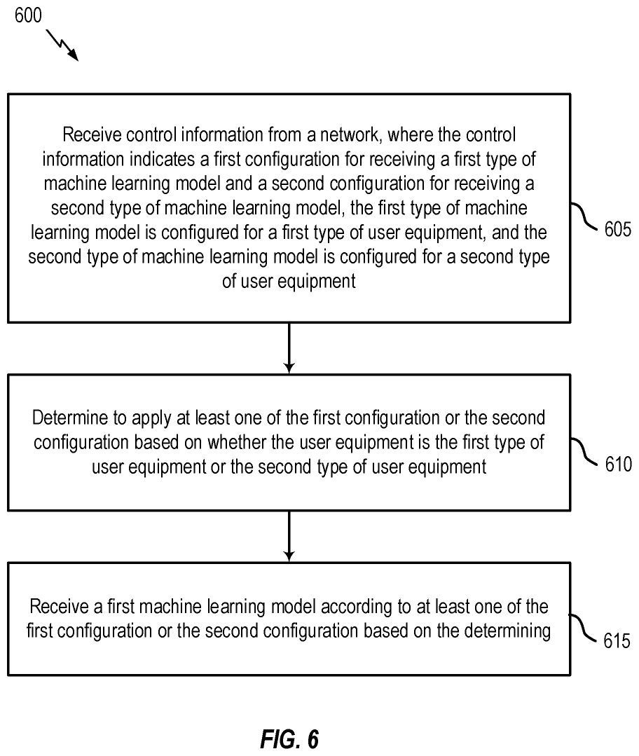

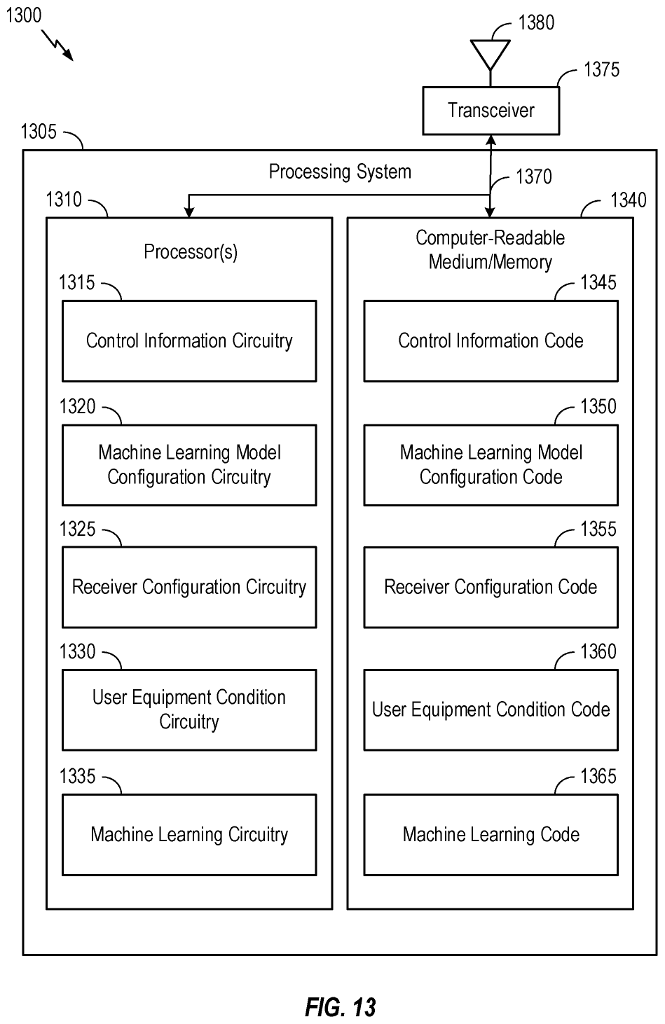

FIG. 6 shows an example of a method 600 for machine learning model configuration for reduced capability user equipment according to aspects of the present disclosure. In some aspects, a user equipment, such as UE 104 for FIGS. 1 and 2, or processing system 1305 of FIG. 13, may perform the method 600.

At operation 605, the system receives, at a user equipment from a network, control information, where the control information indicates a first configuration for receiving a first type of machine learning model and a second configuration for receiving a second type of machine learning model, the first type of machine learning model is configured for a first type of user equipment, and the second type of machine learning model is configured for a second type of user equipment. In some cases, the operations of this step refer to, or may be performed by, a control information circuitry as described with reference to FIG. 13.

At operation 610, the system determines to apply at least one of the first configuration or the second configuration based on whether the user equipment is the first type of user equipment or the second type of user equipment. In some cases, the operations of this step refer to, or may be performed by, a machine learning model configuration circuitry as described with reference to FIG. 13.

At operation 615, the system receives a first machine learning model from the network according to at least one of the first configuration or the second configuration based on the determining. In some cases, the operations of this step refer to, or may be performed by, a receiver configuration circuitry as described with reference to FIG. 13.

In some aspects, method 600 further includes determining to apply the first configuration. In some aspects, method 600 further includes receiving a second machine learning model from the network according to the first configuration. In some aspects, method 600 further includes determining to apply one of the first machine learning model or the second machine learning model based on at least one condition of the user equipment.

In some aspects, the first type of machine learning model results in a lower complexity machine learning operation than the second type of machine learning model.

In some aspects, the first type of user equipment is a reduced capability user equipment and the second type of user equipment is a regular capability user equipment.

In some aspects, the first configuration schedules a first scheduled downlink message and the second configuration schedules a second scheduled downlink message.

In some aspects, the user equipment is the first type of user equipment, determining to apply at least one of the first configuration or the second configuration based on whether the user equipment is the first type of user equipment or the second type of user equipment comprises determining to apply the first configuration, and receiving the first machine learning model from the network according to at least one of the first configuration or the second configuration based on the determining comprises receiving the first machine learning model according to the first configuration.

In some aspects, the user equipment is the second type of user equipment, determining to apply at least one of the first configuration or the second configuration based on whether the user equipment is the first type of user equipment or the second type of user equipment comprises determining to apply the second configuration, and receiving the first machine learning model from the network according to at least one of the first configuration or the second configuration based on the determining comprises receiving the first machine learning model according to the second configuration.

In some aspects, the at least one condition of the user equipment comprises one or more of a battery state of the user equipment, a power state of the user equipment, a RRC state of the user equipment, an active bandwidth part of the user equipment, a condition of a channel between the user equipment and the network, or a mobility state of the user equipment.

In some aspects, the receiving the first machine learning model from the network according to at least one of the first configuration or the second configuration based on the determining comprises receiving the first machine learning model via one or more SIBs.

In some aspects, the control information comprises DCI received via a PDCCH. In some aspects, the DCI comprises a bitmap or a codepoint configured to indicate a scheduled downlink message for receiving the first machine learning model. In some aspects, the DCI includes a CRC scrambled via a cell-specific or user equipment group-specific RNTI. In some aspects, the control information comprises one or more MAC CEs.

In some aspects, the DCI scheduling the one or more MAC CEs includes a CRC scrambled via a cell-specific or user equipment group-specific RNTI.

In some aspects, the control information comprises a RRC message.

In some aspects, the DCI scheduling the RRC message includes a CRC scrambled via a cell-specific or user equipment group-specific RNTI.

In some aspects, the control information comprises one or more SIBs. In some aspects, the DCI scheduling the one or more SIBs includes a CRC scrambled via a cell-specific or user equipment group-specific RNTI.

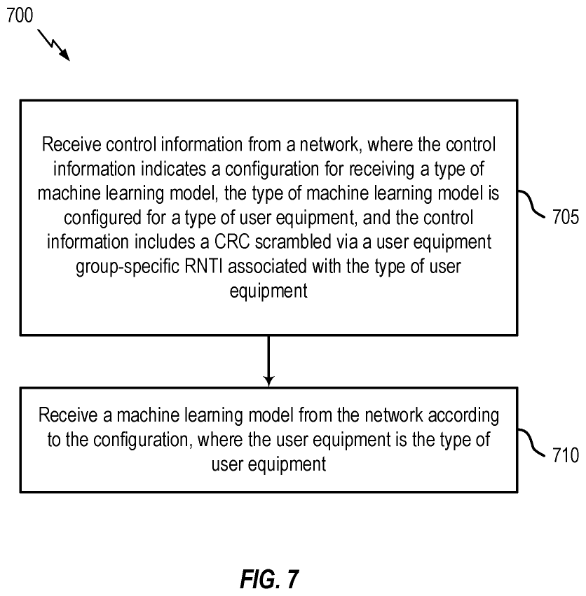

FIG. 7 shows an example of a method 700 for machine learning model configuration for reduced capability user equipment according to aspects of the present disclosure. In some aspects, a user equipment, such as UE 104 for FIGS. 1 and 2, or processing system 1305 of FIG. 13, may perform the method 700.

At operation 705, the system receives, at a user equipment from a network, control information, where the control information indicates a configuration for receiving a type of machine learning model, the type of machine learning model is configured for a type of user equipment, and the control information includes a CRC scrambled via a user equipment group-specific RNTI associated with the type of user equipment. In some cases, the operations of this step refer to, or may be performed by, a control information circuitry as described with reference to FIG. 13.

At operation 710, the system receives a machine learning model from the network according to the configuration, where the user equipment is the type of user equipment. In some cases, the operations of this step refer to, or may be performed by, a receiver configuration circuitry as described with reference to FIG. 13.

In some aspects, the user equipment is a reduced capability user equipment. In other aspects, the user equipment is a regular capability user equipment.

In some aspects, the configuration schedules a downlink message for receiving the machine learning model.

In some aspects, receiving the machine learning model from the network according to the configuration comprises receiving the machine learning model via one or more SIBs.

In some aspects, the control information comprises DCI received via a PDCCH. In some aspects, the DCI comprises a bitmap or a codepoint configured to indicate a scheduled downlink message for receiving the machine learning model.

In some aspects, the control information comprises one or more MAC CEs. In some aspects, the control information comprises a RRC message. In some aspects, the control information comprises one or more SIBs.

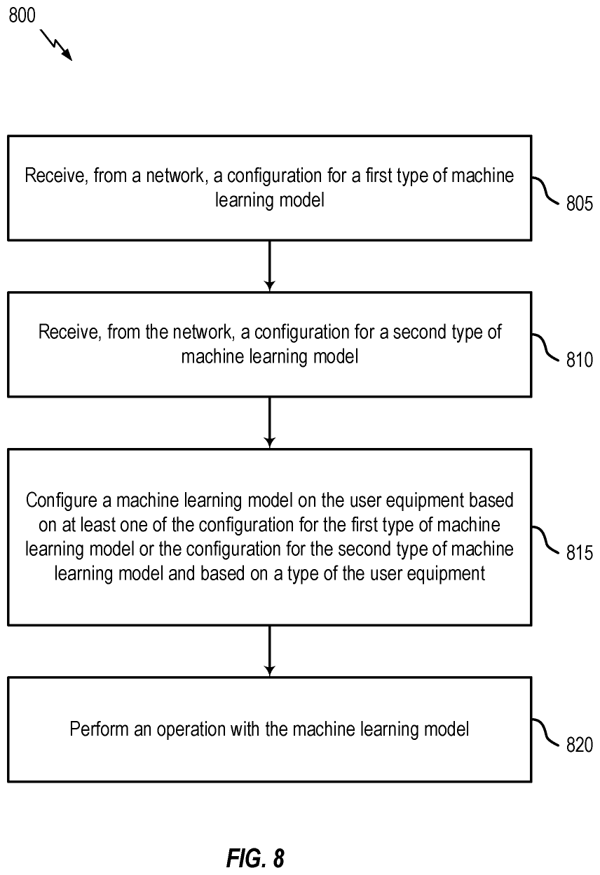

FIG. 8 shows an example of a method 800 for machine learning model configuration for reduced capability user equipment according to aspects of the present disclosure. In some aspects, a user equipment, such as UE 104 for FIGS. 1 and 2, or processing system 1305 of FIG. 13, may perform the method 800.

At operation 805, the system receives, at a user equipment from a network, a configuration for a first type of machine learning model. In some cases, the operations of this step refer to, or may be performed by, a control information circuitry as described with reference to FIG. 13.

At operation 810, the system receives, at the user equipment from the network, a configuration for a second type of machine learning model. In some cases, the operations of this step refer to, or may be performed by, a control information circuitry as described with reference to FIG. 13.

At operation 815, the system configures a machine learning model on the user equipment based on at least one of the configuration for the first type of machine learning model or the configuration for the second type of machine learning model and based on a type of the user equipment. In some cases, the operations of this step refer to, or may be performed by, a machine learning model configuration circuitry as described with reference to FIG. 13.

At operation 820, the system performs an operation with the machine learning model. In some cases, the operations of this step refer to, or may be performed by, a machine learning circuitry as described with reference to FIG. 13.

In some aspects, the first type of machine learning model results in a lower complexity machine learning operation than the second type of machine learning model.

In some aspects, the type of the user equipment is either a reduced capability user equipment or regular capability user equipment.

In some aspects, the configuration for the first type of machine learning model and the configuration for the second type of machine learning model are received in a same message from the network.

In some aspects, the configuration for the first type of machine learning model and the configuration for the second type of machine learning model are received in separate messages from the network.

In some aspects, the configuration for the second type of machine learning model indicates a subset of machine learning model elements from the first type of machine learning model to update during training of the machine learning model. In some aspects, the configuration for the second type of machine learning model indicates a subset of machine learning model elements from the first type of machine learning model to bypass during inferencing. In some aspects, the configuration for the second type of machine learning model indicates at least one function to perform in place of a machine learning model element from the first type of machine learning model.

In some aspects, the type of the user equipment is a reduced capability user equipment.

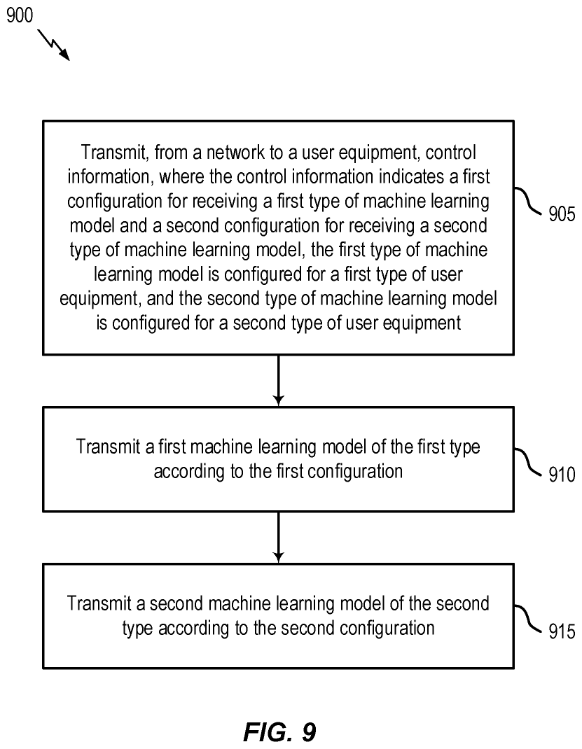

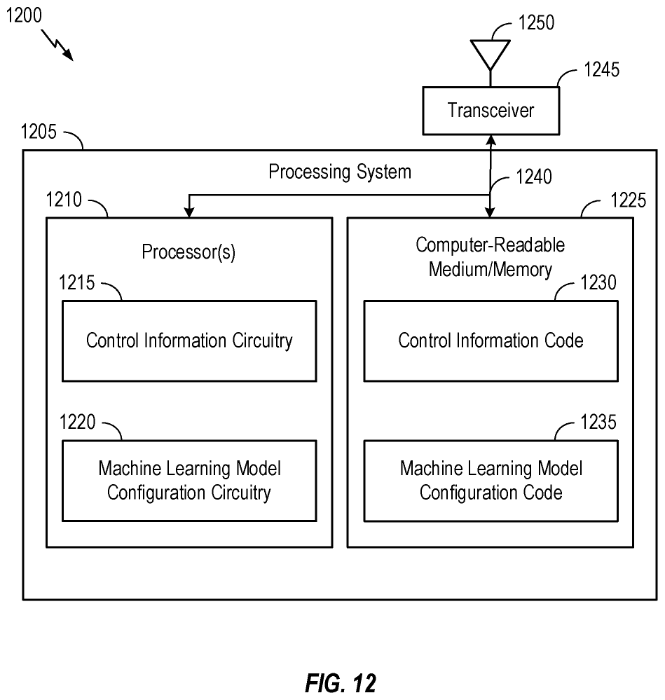

FIG. 9 shows an example of a method 900 for machine learning model configuration for reduced capability user equipment according to aspects of the present disclosure. In some aspects, a user equipment, such as UE 104 for FIGS. 1 and 2, or processing system 1205 of FIG. 12, may perform the method 900.

At operation 905, the system transmits, from a network to a user equipment, control information, where the control information indicates a first configuration for receiving a first type of machine learning model and a second configuration for receiving a second type of machine learning model, the first type of machine learning model is configured for a first type of user equipment, and the second type of machine learning model is configured for a second type of user equipment. In some cases, the operations of this step refer to, or may be performed by, a control information circuitry as described with reference to FIG. 12.

At operation 910, the system transmits a first machine learning model of the first type according to the first configuration. In some cases, the operations of this step refer to, or may be performed by, a machine learning model configuration circuitry as described with reference to FIG. 12.

At operation 915, the system transmits a second machine learning model of the second type according to the second configuration. In some cases, the operations of this step refer to, or may be performed by, a machine learning model configuration circuitry as described with reference to FIG. 12.

In some aspects, the first type of machine learning model results in a lower complexity machine learning operation than the second type of machine learning model. In some aspects, the first type of user equipment is a reduced capability user equipment and the second type of user equipment is a regular capability user equipment. In some aspects, the first configuration schedules a first scheduled downlink message and the second configuration schedules a second scheduled downlink message.

In some aspects, the transmitting the first machine learning model of the first type according to the first configuration comprises transmitting the first machine learning model via one or more SIBs. In some aspects, the control information comprises DCI transmitted via a PDCCH. In some aspects, the DCI comprises a bitmap or a codepoint configured to indicate a scheduled downlink message for receiving the first machine learning model. In some aspects, the DCI includes a CRC scrambled via a cell-specific or user equipment group-specific RNTI. In some aspects, the control information comprises one or more MAC CEs. In some aspects, the DCI scheduling the one or more MAC CEs includes a CRC scrambled via a cell-specific or user equipment group-specific RNTI. In some aspects, the control information comprises a RRC message. In some aspects, the DCI scheduling the RRC message includes a CRC scrambled via a cell-specific or user equipment group-specific RNTI. In some aspects, the control information comprises one or more SIBs. In some aspects, the DCI scheduling the one or more SIBs includes a CRC scrambled via a cell-specific or user equipment group-specific RNTI.

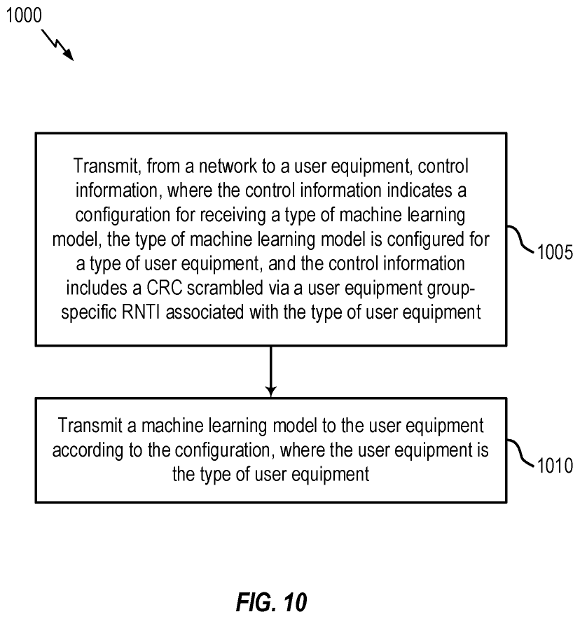

FIG. 10 shows an example of a method 1000 for machine learning model configuration for reduced capability user equipment according to aspects of the present disclosure. In some aspects, a user equipment, such as UE 104 for FIGS. 1 and 2, or processing system 1205 of FIG. 12, may perform the method 1000.

At operation 1005, the system transmits, from a network to a user equipment, control information, where the control information indicates a configuration for receiving a type of machine learning model, the type of machine learning model is configured for a type of user equipment, and the control information includes a CRC scrambled via a user equipment group-specific RNTI associated with the type of user equipment. In some cases, the operations of this step refer to, or may be performed by, a control information circuitry as described with reference to FIG. 12.

At operation 1010, the system transmits a machine learning model to the user equipment according to the configuration, where the user equipment is the type of user equipment. In some cases, the operations of this step refer to, or may be performed by, a machine learning model configuration circuitry as described with reference to FIG. 12.

In some aspects, the user equipment is a reduced capability user equipment. In some aspects, the user equipment is a regular capability user equipment. In some aspects, the configuration schedules a downlink message for transmitting the machine learning model. In some aspects, the transmitting the machine learning model from the network to the user equipment according to the configuration comprises transmitting the machine learning model via one or more SIBs. In some aspects, the control information comprises DCI transmitted via a PDCCH. In some aspects, the DCI comprises a bitmap or a codepoint configured to indicate a scheduled downlink message for receiving the machine learning model. In some aspects, the control information comprises one or more MAC CEs. In some aspects, the control information comprises a RRC message. In some aspects, the control information comprises one or more SIBs.

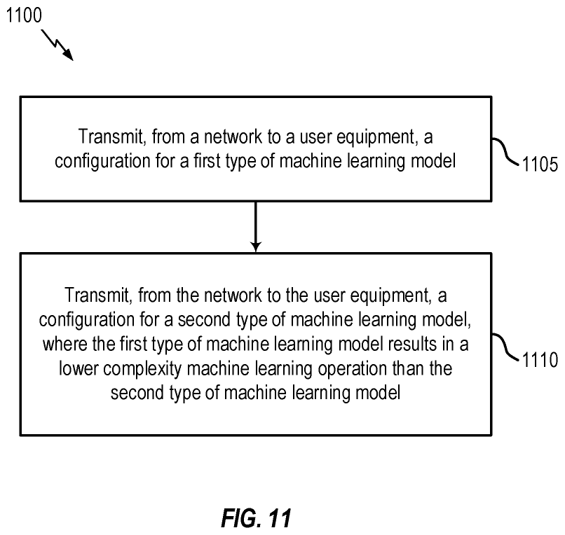

FIG. 11 shows an example of a method 1100 for machine learning model configuration for reduced capability user equipment according to aspects of the present disclosure. In some aspects, a user equipment, such as UE 104 for FIGS. 1 and 2, or processing system 1205 of FIG. 12, may perform the method 1100.

At operation 1105, the system transmits, from a network to a user equipment, a configuration for a first type of machine learning model. In some cases, the operations of this step refer to, or may be performed by, a machine learning model configuration circuitry as described with reference to FIG. 12.

At operation 1110, the system transmits, from the network to the user equipment, a configuration for a second type of machine learning model, where the first type of machine learning model results in a lower complexity machine learning operation than the second type of machine learning model. In some cases, the operations of this step refer to, or may be performed by, a machine learning model configuration circuitry as described with reference to FIG. 12.

In some aspects, the configuration for the first type of machine learning model and the configuration for the second type of machine learning model are transmitted in a same message from the network.

In some aspects, the configuration for the first type of machine learning model and the configuration for the second type of machine learning model are transmitted in separate messages from the network.

### Example Wireless Communication Devices

FIG. 12 depicts an example communications device 1200 that includes various components operable, configured, or adapted to perform operations for the techniques disclosed herein, such as the operations depicted and described with respect to FIGS. 4A-5 and 9-11. In some examples, communication device may be a base station 102 as described, for example with respect to FIGS. 1 and 2.

Communications device 1200 includes a processing system 1205 coupled to a transceiver 1245 (e.g., a transmitter and/or a receiver). Transceiver 1245 is configured to transmit (or send) and receive signals for the communications device 1200 via an antenna 1250, such as the various signals as described herein.

Processing system 1205 may be configured to perform processing functions for communications device 1200, including processing signals received and/or to be transmitted by communications device 1200.

Processing system 1205 includes one or more processors 1210 coupled to a computer-readable medium/memory 1225 via a bus 1240. In certain aspects, computer-readable medium/memory 1225 is configured to store instructions (e.g., computer-executable code) that when executed by the one or more processors 1210, cause the one or more processors 1210 to perform the operations illustrated in FIGS. 4A-5 and 9-11, or other operations for performing the various techniques discussed herein.

Various components of communications device 1200 may provide means for performing the methods described herein, including with respect to FIGS. 4A-5 and 9-11.

In some examples, means for transmitting or sending (or means for outputting for transmission) may include the transceivers 232 and/or antenna 234 of the base station 102 illustrated in FIG. 2 and/or transceiver 1245 and antenna 1250 of the communication device in FIG. 12.

In some examples, means for receiving (or means for obtaining) may include the transceivers 232 and/or antenna 234 of the base station illustrated in FIG. 2 and/or transceiver 1245 and antenna 1250 of the communication device in FIG. 12.

In some examples, means for configuring machine learning models may include various processing system 1205 components, such as: the one or more processors 1210 in FIG. 12, or aspects of the base station 102 depicted in FIG. 2, including receive processor 238, transmit processor 220, TX MIMO processor 230, and/or controller/processor 240.

In the depicted example, the one or more processors 1210 include circuitry configured to implement the code stored in the computer-readable medium/memory, including control information circuitry 1215 and machine learning model configuration circuitry 1220.

According to some aspects, control information circuitry 1215 transmits, from a network to a user equipment, control information, where the control information indicates a first configuration for receiving a first type of machine learning model and a second configuration for receiving a second type of machine learning model, the first type of machine learning model is configured for a first type of user equipment, and the second type of machine learning model is configured for a second type of user equipment.

In some examples, the first type of user equipment is a reduced capability user equipment and the second type of user equipment is a regular capability user equipment. In some examples, the control information includes DCI transmitted via a PDCCH.

In some examples, the DCI includes a bitmap or a codepoint configured to indicate a scheduled downlink message for receiving the first machine learning model.

In some examples, the DCI includes a CRC scrambled via a cell-specific or user equipment group-specific RNTI.

In some examples, the control information includes one or more MAC CEs.

In some examples, the DCI scheduling the one or more MAC CEs includes a CRC scrambled via a cell-specific or user equipment group-specific RNTI.

In some examples, the control information includes a RRC message.

In some examples, the DCI scheduling the RRC message includes a CRC scrambled via a cell-specific or user equipment group-specific RNTI. In some examples, the control information includes one or more SIBs.

In some examples, the DCI scheduling the one or more SIBs includes a CRC scrambled via a cell-specific or user equipment group-specific RNTI.

According to some aspects, control information circuitry 1215 transmits, from a network to a user equipment, control information, where the control information indicates a configuration for receiving a type of machine learning model, the type of machine learning model is configured for a type of user equipment, and the control information includes a CRC scrambled via a user equipment group-specific RNTI associated with the type of user equipment.

In some examples, the user equipment is a reduced capability user equipment. In some examples, the user equipment is a regular capability user equipment.

In some examples, transmitting the machine learning model from the network to the user equipment according to the configuration includes transmitting the machine learning model via one or more SIBs. In some examples, the control information includes DCI transmitted via a PDCCH. In some examples, the DCI includes a bitmap or a codepoint configured to indicate a scheduled downlink message for receiving the machine learning model. In some examples, the control information includes one or more MAC CEs. In some examples, the control information includes a RRC message. In some examples, the control information includes one or more SIBs.

According to some aspects, machine learning model configuration circuitry 1220 transmits a first machine learning model of the first type according to the first configuration. In some examples, machine learning model configuration circuitry 1220 transmits a second machine learning model of the second type according to the second configuration. In some examples, the first type of machine learning model results in a lower complexity machine learning operation than the second type of machine learning model. In some examples, the first configuration schedules a first scheduled downlink message and the second configuration schedules a second scheduled downlink message. In some examples, the transmitting the first machine learning model of the first type according to the first configuration includes transmitting the first machine learning model via one or more SIBs.

According to some aspects, machine learning model configuration circuitry 1220 transmits a machine learning model to the user equipment according to the configuration, where the user equipment is the type of user equipment. In some examples, the configuration schedules a downlink message for transmitting the machine learning model.

According to some aspects, machine learning model configuration circuitry 1220 transmits, from a network to a user equipment, a configuration for a first type of machine learning model. In some examples, machine learning model configuration circuitry 1220 transmits, from the network to the user equipment, a configuration for a second type of machine learning model, where the first type of machine learning model results in a lower complexity machine learning operation than the second type of machine learning model.

In some examples, the configuration for the second type of machine learning model indicates at least one of a subset of machine learning model elements from the first type of machine learning model to update during training of a machine learning model, a subset of machine learning model elements from the first type of machine learning model to bypass during inferencing with the machine learning model, or at least one function to perform in place of a machine learning model element from the first type of machine learning model.

In some examples, the configuration for the first type of machine learning model and the configuration for the second type of machine learning model are transmitted in a same message from the network. In some examples, the configuration for the first type of machine learning model and the configuration for the second type of machine learning model are transmitted in separate messages from the network.

Notably, FIG. 12 is just on example, and many other examples and configurations of communication device are possible.

FIG. 13 depicts an example communications device 1300 that includes various components operable, configured, or adapted to perform operations for the techniques disclosed herein, such as the operations depicted and described with respect to FIGS. 4A-5 and 6-8. In some examples, communication device may be a user equipment 104 as described, for example with respect to FIGS. 1 and 2.

Communications device 1300 includes a processing system 1305 coupled to a transceiver 1375 (e.g., a transmitter and/or a receiver). Transceiver 1375 is configured to transmit (or send) and receive signals for the communications device 1300 via an antenna 1380, such as the various signals as described herein. Processing system 1305 may be configured to perform processing functions for communications device 1300, including processing signals received and/or to be transmitted by communications device 1300.

Processing system 1305 includes one or more processors 1310 coupled to a computer-readable medium/memory 1340 via a bus 1370. In certain aspects, computer-readable medium/memory 1340 is configured to store instructions (e.g., computer-executable code) that when executed by the one or more processors 1310, cause the one or more processors 1310 to perform the operations illustrated in FIGS. 4A-5 and 6-8, or other operations for performing the various techniques discussed herein.

Various components of communications device 1300 may provide means for performing the methods described herein, including with respect to FIGS. 4A-5 and 6-8.

In some examples, means for transmitting or sending (or means for outputting for transmission) may include the transceivers 254 and/or antenna 252 of the user equipment 104 illustrated in FIG. 2 and/or transceiver 1375 and antenna 1380 of the communication device in FIG. 13.

In some examples, means for receiving (or means for obtaining) may include the transceivers 254 and/or antenna 252 of the user equipment 104 illustrated in FIG. 2 and/or transceiver 1375 and antenna 1380 of the communication device in FIG. 13.

In some examples, means for configuring machine learning models may include various processing system 1305 components, such as: the one or more processors 1310 in FIG. 13, or aspects of the user equipment 104 depicted in FIG. 2, including receive processor 258, transmit processor 264, TX MIMO processor 266, and/or controller/processor 280.

In some examples, one or more processors 1310 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1310 are configured to operate a memory array using a memory controller. In other cases, a memory controller is integrated into the one or more processors 1310. In some cases, the one or more processors 1310 are configured to execute computer-readable instructions stored in a memory to perform various functions. In some aspects, one or more processors 1310 include special purpose components for modem processing, baseband processing, digital signal processing, or transmission processing.

A machine learning model is a type of computer algorithm and hardware combination that is capable of learning specific patterns without being explicitly programmed, but through iterations over known data. A machine learning model may refer to a cognitive model that includes input nodes, hidden nodes, and output nodes. Nodes in the machine learning model may have an activation function that computes whether the node is activated based on the output of previous nodes. Training the system may involve supplying values for the inputs, and modifying edge weights and activation functions (algorithmically or randomly) until the result closely approximates a set of desired outputs.

A neural processing unit (NPU) is a microprocessor that specializes in the acceleration of machine learning algorithms. For example, an NPU may operate on predictive models such as artificial neural networks (ANNs) or random forests (RFs). In some cases, an NPU is designed in a way that makes it unsuitable for general purpose computing such as that performed by a Central Processing Unit (CPU). Additionally or alternatively, the software support for an NPU may not be developed for general purpose computing.

In some examples, the machine learning model (or machine learning model configuration) may include one or more aspects of an ANN. An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. Each node and edge is associated with one or more node weights that determine how the signal is processed and transmitted. During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some examples, a machine learning model (or machine learning model configuration) may include one or more aspects of a convolutional neural network (CNN). A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

A transceiver 1375 may communicate bi-directionally, via antennas 1380, wired, or wireless links as described above. For example, the transceiver 1375 may represent a wireless transceiver 1375 and may communicate bi-directionally with another wireless transceiver 1375. The transceiver 1375 may also include or be connected to a modem to modulate the packets and provide the modulated packets to for transmission, and to demodulate received packets. In some examples, transceiver 1375 may be tuned to operate at specified frequencies. For example, a modem can configure the transceiver 1375 to operate at a specified frequency and power level based on the communication protocol used by the modem.

In the depicted example, the one or more processors 1310 include circuitry configured to implement the code stored in the computer-readable medium/memory, including control information circuitry 1315, machine learning model configuration circuitry 1320, receiver configuration circuitry 1325, user equipment condition circuitry 1330, and machine learning circuitry 1335.

According to some aspects, control information circuitry 1315 receives, at a user equipment from a network, control information, where the control information indicates a first configuration for receiving a first type of machine learning model and a second configuration for receiving a second type of machine learning model, the first type of machine learning model is configured for a first type of user equipment, and the second type of machine learning model is configured for a second type of user equipment.

In some examples, the control information includes DCI received via a PDCCH. In some examples, the DCI includes a bitmap or a codepoint configured to indicate a scheduled downlink message for receiving the first machine learning model.

In some examples, the DCI includes a CRC scrambled via a cell-specific or user equipment group-specific RNTI. In some examples, the control information includes one or more MAC CEs.

In some examples, the DCI scheduling the one or more MAC CEs includes a CRC scrambled via a cell-specific or user equipment group-specific RNTI. In some examples, the control information includes a RRC message.

In some examples, the DCI scheduling the RRC message includes a CRC scrambled via a cell-specific or user equipment group-specific RNTI. In some examples, the control information includes one or more SIBs.

In some examples, the DCI scheduling the one or more SIBs includes a CRC scrambled via a cell-specific or user equipment group-specific RNTI.

According to some aspects, control information circuitry 1315 receives, at a user equipment from a network, control information, where the control information indicates a configuration for receiving a type of machine learning model, the type of machine learning model is configured for a type of user equipment, and the control information includes a CRC scrambled via a user equipment group-specific RNTI associated with the type of user equipment.

According to some aspects, control information circuitry 1315 receives, at a user equipment from a network, a configuration for a first type of machine learning model. In some examples, control information circuitry 1315 receives, at the user equipment from the network, a configuration for a second type of machine learning model.

In some examples, the configuration for the first type of machine learning model and the configuration for the second type of machine learning model are received in a same message from the network.

In some examples, the configuration for the first type of machine learning model and the configuration for the second type of machine learning model are received in separate messages from the network.

In some examples, the configuration for the second type of machine learning model indicates a subset of machine learning model elements from the first type of machine learning model to update during training of the machine learning model. In some examples, the configuration for the second type of machine learning model indicates a subset of machine learning model elements from the first type of machine learning model to bypass during inferencing.

In some examples, the configuration for the second type of machine learning model indicates at least one function to perform in place of a machine learning model element from the first type of machine learning model.

According to some aspects, machine learning model configuration circuitry 1320 determines to apply at least one of the first configuration or the second configuration based on whether the user equipment is the first type of user equipment or the second type of user equipment.

In some examples, the first type of machine learning model results in a lower complexity machine learning operation than the second type of machine learning model. In some examples, the first type of user equipment is a reduced capability user equipment and the second type of user equipment is a regular capability user equipment.

In some examples, the first configuration schedules a first scheduled downlink message and the second configuration schedules a second scheduled downlink message. In some examples, machine learning model configuration circuitry 1320 determines to apply the first configuration.

According to some aspects, machine learning model configuration circuitry 1320 configures a machine learning model on the user equipment based on at least one of the configuration for the first type of machine learning model or the configuration for the second type of machine learning model and based on a type of the user equipment. In some examples, the type of the user equipment is either a reduced capability user equipment or regular capability user equipment.

According to some aspects, receiver configuration circuitry 1325 receives a first machine learning model from the network according to at least one of the first configuration or the second configuration based on the determining.

In some examples, the user equipment is the first type of user equipment, determining to apply at least one of the first configuration or the second configuration based on whether the user equipment is the first type of user equipment or the second type of user equipment includes determining to apply the first configuration, and receiving the first machine learning model from the network according to at least one of the first configuration or the second configuration based on the determining includes receiving the first machine learning model according to the first configuration.

In some examples, the user equipment is the second type of user equipment, determining to apply at least one of the first configuration or the second configuration based on whether the user equipment is the first type of user equipment or the second type of user equipment includes determining to apply the second configuration, and receiving the first machine learning model from the network according to at least one of the first configuration or the second configuration based on the determining includes receiving the first machine learning model according to the second configuration.

In some examples, receiver configuration circuitry 1325 receives a second machine learning model from the network according to the first configuration. In some examples, the receiving the first machine learning model from the network according to at least one of the first configuration or the second configuration based on the determining includes receiving the first machine learning model via one or more SIBs.

According to some aspects, receiver configuration circuitry 1325 receives a machine learning model from the network according to the configuration, where the user equipment is the type of user equipment.

In some examples, the configuration schedules a downlink message for receiving the machine learning model. In some examples, the receiving the machine learning model from the network according to the configuration includes receiving the machine learning model via one or more SIBs.

According to some aspects, user equipment condition circuitry 1330 determines to apply one of the first machine learning model or the second machine learning model based on at least one condition of the user equipment. In some examples, the at least one condition of the user equipment includes one or more of a battery state of the user equipment, a power state of the user equipment, a RRC state of the user equipment, an active bandwidth part of the user equipment, a condition of a channel between the user equipment and the network, or a mobility state of the user equipment.

According to some aspects, machine learning circuitry 1335 performs an operation with the configured machine learning model.

In the depicted example, computer-readable medium/memory 1340 stores control information code 1345, machine learning model configuration code 1350, receiver configuration code 1355, user equipment condition code 1360, and machine learning code 1365.

Notably, FIG. 13 is just one example, and many other examples and configurations of communication device are possible.

### Example Clauses

Implementation examples are described in the following numbered clauses:

Clause 1: A method, comprising: receiving, at a user equipment from a network, control information, wherein the control information indicates a first configuration for receiving a first type of machine learning model and a second configuration for receiving a second type of machine learning model, the first type of machine learning model is configured for a first type of user equipment, and the second type of machine learning model is configured for a second type of user equipment; determining to apply at least one of the first configuration or the second configuration based on whether the user equipment is the first type of user equipment or the second type of user equipment, and receiving a first machine learning model from the network according to at least one of the first configuration or the second configuration based on the determining.

Clause 2: The method of Clause 1, wherein: the first type of machine learning model results in a lower complexity machine learning operation than the second type of machine learning model.

Clause 3: The method of Clause 2, wherein: the first type of user equipment is a reduced capability user equipment and the second type of user equipment is a regular capability user equipment.

Clause 4: The method of Clause 3, wherein: the first configuration schedules a first scheduled downlink message and the second configuration schedules a second scheduled downlink message.

Clause 5: The method of Clause 3, wherein: the user equipment is the first type of user equipment, determining to apply at least one of the first configuration or the second configuration based on whether the user equipment is the first type of user equipment or the second type of user equipment comprises determining to apply the first configuration, and receiving the first machine learning model from the network according to at least one of the first configuration or the second configuration based on the determining comprises receiving the first machine learning model according to the first configuration.

Clause 6: The method of Clause 3, wherein: the user equipment is the second type of user equipment, determining to apply at least one of the first configuration or the second configuration based on whether the user equipment is the first type of user equipment or the second type of user equipment comprises determining to apply the second configuration, and receiving the first machine learning model from the network according to at least one of the first configuration or the second configuration based on the determining comprises receiving the first machine learning model according to the second configuration.

Clause 7: The method of Clause 6, further comprising: determining to apply the first configuration; and receiving a second machine learning model from the network according to the first configuration.

Clause 8: The method of Clause 7, further comprising: determining to apply one of the first machine learning model or the second machine learning model based on at least one condition of the user equipment.

Clause 9: The method of Clause 8, wherein: the at least one condition of the user equipment comprises one or more of a battery state of the user equipment, a power state of the user equipment, a RRC state of the user equipment, an active bandwidth part of the user equipment, a condition of a channel between the user equipment and the network, or a mobility state of the user equipment.

Clause 10: The method of any one of Clauses 1-9, wherein: the receiving the first machine learning model from the network according to at least one of the first configuration or the second configuration based on the determining comprises receiving the first machine learning model via one or more SIBs.

Clause 11: The method of any one of Clauses 1-10, wherein: the control information comprises DCI received via a PDCCH.

Clause 12: The method of Clause 11, wherein: the DCI comprises a bitmap or a codepoint configured to indicate a scheduled downlink message for receiving the first machine learning model.

Clause 13: The method of Clause 11, wherein: the DCI includes a CRC scrambled via a cell-specific or user equipment group-specific RNTI.

Clause 14: The method of any one of Clauses 1-13, wherein: the control information comprises one or more MAC CEs.

Clause 15: The method of Clause 14, wherein: the DCI scheduling the one or more MAC CEs includes a CRC scrambled via a cell-specific or user equipment group-specific RNTI.

Clause 16: The method of any one of Clauses 1-15, wherein: the control information comprises a RRC message.

Clause 17: The method of Clause 16, wherein: the DCI scheduling the RRC message includes a CRC scrambled via a cell-specific or user equipment group-specific RNTI.

Clause 18: The method of any one of Clauses 1-17, wherein: the control information comprises one or more SIBs.

Clause 19: The method of Clause 18, wherein: the DCI scheduling the one or more SIBs includes a CRC scrambled via a cell-specific or user equipment group-specific RNTI.

Clause 20: A processing system, comprising: a memory comprising computer-executable instructions; one or more processors configured to execute the computer-executable instructions and cause the processing system to perform a method in accordance with any one of Clauses 1-19.

Clause 21: A processing system, comprising means for performing a method in accordance with any one of Clauses 1-19.

Clause 22: A non-transitory computer-readable medium comprising computer-executable instructions that, when executed by one or more processors of a processing system, cause the processing system to perform a method in accordance with any one of Clauses 1-19.

Clause 23: A computer program product embodied on a computer-readable storage medium comprising code for performing a method in accordance with any one of Clauses 1-19.

Clause 24: A method, comprising: receiving, at a user equipment from a network, control information, wherein the control information indicates a configuration for receiving a type of machine learning model, the type of machine learning model is configured for a type of user equipment, and the control information includes a CRC scrambled via a user equipment group-specific RNTI associated with the type of user equipment; and receiving a machine learning model from the network according to the configuration, wherein the user equipment is the type of user equipment.

Clause 25: The method of Clause 24, wherein: the user equipment is a reduced capability user equipment.

Clause 26: The method of Clause 25, wherein: the user equipment is a regular capability user equipment.

Clause 27: The method of any one of Clauses 24-26, wherein: the configuration schedules a downlink message for receiving the machine learning model.

Clause 28: The method of any one of Clauses 24-27, wherein: the receiving the machine learning model from the network according to the configuration comprises receiving the machine learning model via one or more SIBs

Clause 29: The method of any one of Clauses 24-28, wherein: the control information comprises DCI received via a PDCCH.

Clause 30: The method Clause 29, wherein: the DCI comprises a bitmap or a codepoint configured to indicate a scheduled downlink message for receiving the machine learning model.

Clause 31: The method of any one of Clauses 24-30, wherein: the control information comprises one or more MAC CEs.

Clause 32: The method of any one of Clauses 24-31, wherein: the control information comprises a RRC message.

Clause 33: The method of any one of Clauses 24-32, wherein: the control information comprises one or more SIBs.

Clause 34: A processing system, comprising: a memory comprising computer-executable instructions; one or more processors configured to execute the computer-executable instructions and cause the processing system to perform a method in accordance with any one of Clauses 24-33.

Clause 35: A processing system, comprising means for performing a method in accordance with any one of Clauses 24-33.

Clause 36: A non-transitory computer-readable medium comprising computer-executable instructions that, when executed by one or more processors of a processing system, cause the processing system to perform a method in accordance with any one of Clauses 24-33.

Clause 37: A computer program product embodied on a computer-readable storage medium comprising code for performing a method in accordance with any one of Clauses 24-33.

Clause 38: A method, comprising: receiving, at a user equipment from a network, a configuration for a first type of machine learning model; receiving, at the user equipment from the network, a configuration for a second type of machine learning model; configuring a machine learning model on the user equipment based on at least one of the configuration for the first type of machine learning model or the configuration for the second type of machine learning model and based on a type of the user equipment; and performing an operation with the machine learning model.

Clause 39: The method of Clause 38, wherein: the first type of machine learning model results in a lower complexity machine learning operation than the second type of machine learning model.

Clause 40: The method of Clause 39, wherein: the type of the user equipment is either a reduced capability user equipment or regular capability user equipment.

Clause 41: The method of any one of Clauses 38-40, wherein: the configuration for the first type of machine learning model and the configuration for the second type of machine learning model are received in a same message from the network.

Clause 42: The method of any one of Clauses 38-41, wherein: the configuration for the first type of machine learning model and the configuration for the second type of machine learning model are received in separate messages from the network.

Clause 43: The method of any one of Clauses 38-42, wherein: the configuration for the second type of machine learning model indicates a subset of machine learning model elements from the first type of machine learning model to update during training of the machine learning model.

Clause 44: The method of any one of Clauses 38-43, wherein: the configuration for the second type of machine learning model indicates a subset of machine learning model elements from the first type of machine learning model to bypass during inferencing.

Clause 45: The method of any one of Clauses 38-44, wherein: the configuration for the second type of machine learning model indicates at least one function to perform in place of a machine learning model element from the first type of machine learning model.

Clause 46: The method of any one of Clauses 38-45, wherein: the type of the user equipment is a reduced capability user equipment.

Clause 47: A processing system, comprising: a memory comprising computer-executable instructions; one or more processors configured to execute the computer-executable instructions and cause the processing system to perform a method in accordance with any one of Clauses 38-46.

Clause 48: A processing system, comprising means for performing a method in accordance with any one of Clauses 38-46.

Clause 49: A non-transitory computer-readable medium comprising computer-executable instructions that, when executed by one or more processors of a processing system, cause the processing system to perform a method in accordance with any one of Clauses 38-46.

Clause 50: A computer program product embodied on a computer-readable storage medium comprising code for performing a method in accordance with any one of Clauses 38-46.

Clause 51: A method, comprising: transmitting, from a network to a user equipment, control information, wherein the control information indicates a first configuration for receiving a first type of machine learning model and a second configuration for receiving a second type of machine learning model, the first type of machine learning model is configured for a first type of user equipment, and the second type of machine learning model is configured for a second type of user equipment; transmitting a first machine learning model of the first type according to the first configuration; and transmitting a second machine learning model of the second type according to the second configuration.

Clause 52: The method of Clause 51, wherein: the first type of machine learning model results in a lower complexity machine learning operation than the second type of machine learning model.

Clause 53: The method of Clause 52, wherein: the first type of user equipment is a reduced capability user equipment and the second type of user equipment is a regular capability user equipment.

Clause 54: The method of Clause 53, wherein: the first configuration schedules a first scheduled downlink message and the second configuration schedules a second scheduled downlink message.

Clause 55: The method of any one of Clauses 51-54, wherein: the transmitting the first machine learning model of the first type according to the first configuration comprises transmitting the first machine learning model via one or more SIBs.

Clause 56: The method of any one of Clauses 51-55, wherein: the control information comprises DCI transmitted via a PDCCH.

Clause 57: The method of Clause 56, wherein: the DCI comprises a bitmap or a codepoint configured to indicate a scheduled downlink message for receiving the first machine learning model.

Clause 58: The method of Clause 56, wherein: the DCI includes a CRC scrambled via a cell-specific or user equipment group-specific RNTI.

Clause 59: The method of any one of Clauses 51-58, wherein: the control information comprises one or more MAC CEs.

Clause 60: The method of Clause 59, wherein: the DCI scheduling the one or more MAC CEs includes a CRC scrambled via a cell-specific or user equipment group-specific RNTI.

Clause 61: The method of any one of Clauses 51-60, wherein: the control information comprises a RRC message.

Clause 62: The method of Clause 61, wherein: the DCI scheduling the RRC message includes a CRC scrambled via a cell-specific or user equipment group-specific RNTI.

Clause 63: The method of any one of Clauses 51-62, wherein: the control information comprises one or more SIBs.

Clause 64: The method of Clause 63, wherein: the DCI scheduling the one or more SIBs includes a CRC scrambled via a cell-specific or user equipment group-specific RNTI.

Clause 65: A processing system, comprising: a memory comprising computer-executable instructions; one or more processors configured to execute the computer-executable instructions and cause the processing system to perform a method in accordance with any one of Clauses 51-64.

Clause 66: A processing system, comprising means for performing a method in accordance with any one of Clauses 51-64.

Clause 67: A non-transitory computer-readable medium comprising computer-executable instructions that, when executed by one or more processors of a processing system, cause the processing system to perform a method in accordance with any one of Clauses 51-64.

Clause 68: A computer program product embodied on a computer-readable storage medium comprising code for performing a method in accordance with any one of Clauses 51-64.

Clause 69: A method, comprising: transmitting, from a network to a user equipment, control information, wherein the control information indicates a configuration for receiving a type of machine learning model, the type of machine learning model is configured for a type of user equipment, and the control information includes a CRC scrambled via a user equipment group-specific RNTI associated with the type of user equipment; and transmitting a machine learning model to the user equipment according to the configuration, wherein the user equipment is the type of user equipment.

Clause 70: The method of Clause 69, wherein: the user equipment is a reduced capability user equipment.

Clause 71: The method of any one of Clauses 69 and 70, wherein: the user equipment is a regular capability user equipment.

Clause 72: The method of any one of Clauses 69-71, wherein: the configuration schedules a downlink message for transmitting the machine learning model.

Clause 73: The method of any one of Clauses 69-72, wherein: the transmitting the machine learning model from to the user equipment according to the configuration comprises transmitting the machine learning model via one or more SIBs.

Clause 74: The method of any one of Clauses 69-73, wherein: the control information comprises DCI transmitted via a PDCCH.

Clause 75: The method of Clause 74, wherein: the DCI comprises a bitmap or a codepoint configured to indicate a scheduled downlink message for receiving the machine learning model.

Clause 76: The method of any one of Clauses 69-75, wherein: the control information comprises one or more MAC CEs.

Clause 77: The method of any one of Clauses 69-76, wherein: the control information comprises a RRC message.

Clause 78: The method of any one of Clauses 69-77, wherein: the control information comprises one or more SIBs.

Clause 79: A processing system, comprising: a memory comprising computer-executable instructions; one or more processors configured to execute the computer-executable instructions and cause the processing system to perform a method in accordance with any one of Clauses 69-78.

Clause 80: A processing system, comprising means for performing a method in accordance with any one of Clauses 69-78.

Clause 81: A non-transitory computer-readable medium comprising computer-executable instructions that, when executed by one or more processors of a processing system, cause the processing system to perform a method in accordance with any one of Clauses 69-78.

Clause 82: A computer program product embodied on a computer-readable storage medium comprising code for performing a method in accordance with any one of Clauses 69-78.

Clause 83: A method, comprising: transmitting, from a network to a user equipment, a configuration for a first type of machine learning model; and transmitting, from the network to the user equipment, a configuration for a second type of machine learning model, wherein the first type of machine learning model results in a lower complexity machine learning operation than the second type of machine learning model, and wherein the configuration for the second type of machine learning model indicates at least one of a subset of machine learning model elements from the first type of machine learning model to update during training of a machine learning model, a subset of machine learning model elements from the first type of machine learning model to bypass during inferencing with the machine learning model, or at least one function to perform in place of a machine learning model element from the first type of machine learning model.

Clause 84: The method of Clause 83, wherein: the configuration for the first type of machine learning model and the configuration for the second type of machine learning model are transmitted in a same message from the network.

Clause 85: The method of Clause 83, wherein: the configuration for the first type of machine learning model and the configuration for the second type of machine learning model are transmitted in separate messages from the network.

Clause 86: A processing system, comprising: a memory comprising computer-executable instructions; one or more processors configured to execute the computer-executable instructions and cause the processing system to perform a method in accordance with any one of Clauses 83-85.

Clause 87: A processing system, comprising means for performing a method in accordance with any one of Clauses 83-85.

Clause 88: A non-transitory computer-readable medium comprising computer-executable instructions that, when executed by one or more processors of a processing system, cause the processing system to perform a method in accordance with any one of Clauses 83-85.

Clause 89: A computer program product embodied on a computer-readable storage medium comprising code for performing a method in accordance with any one of Clauses 83-85.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHZ spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHZ) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHZ and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ. WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of configuring machine learning models for different types of user equipment, including reduced capability user equipment, in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a user equipment, comprising at least one memory comprising computer-executable instructions; and one or more processors configured to execute the computer-executable instructions and cause the apparatus to:
receive, at a user equipment from a network, control information, wherein:
the control information indicates a first configuration for receiving a first type of machine learning model and a second configuration for receiving a second type of machine learning model,
the first type of machine learning model is configured for a first type of user equipment, and
the second type of machine learning model is configured for a second type of user equipment;
determine to apply at least one of the first configuration or the second configuration based on whether the user equipment is the first type of user equipment or the second type of user equipment; and
receive a first machine learning model from the network according to at least one of the first configuration or the second configuration based on the determining.

2. The apparatus of claim 1, wherein the first type of machine learning model results in a lower complexity machine learning operation than the second type of machine learning model.

3. The apparatus of claim 2, wherein the first type of user equipment is a reduced capability user equipment and the second type of user equipment is a regular capability user equipment.

4. The apparatus of claim 3, wherein:
the first configuration schedules a first scheduled downlink message, and
the second configuration schedules a second scheduled downlink message.

5. The apparatus of claim 3, wherein:
the user equipment is the first type of user equipment,
determining to apply at least one of the first configuration or the second configuration based on whether the user equipment is the first type of user equipment or the second type of user equipment comprises determining to apply the first configuration, and
receiving the first machine learning model from the network according to at least one of the first configuration or the second configuration based on the determining comprises receiving the first machine learning model according to the first configuration.

6. The apparatus of claim 3, wherein:
the user equipment is the second type of user equipment,
determining to apply at least one of the first configuration or the second configuration based on whether the user equipment is the first type of user equipment or the second type of user equipment comprises determining to apply the second configuration, and
receiving the first machine learning model from the network according to at least one of the first configuration or the second configuration based on the determining comprises receiving the first machine learning model according to the second configuration.

7. The apparatus of claim 6, wherein the one or more processors are further configured to execute the computer-executable instructions and cause the apparatus to:
determine to apply the first configuration; and
receive a second machine learning model from the network according to the first configuration.

8. The apparatus of claim 7, wherein the one or more processors are further configured to execute the computer-executable instructions and cause the apparatus to determine to apply one of the first machine learning model or the second machine learning model based on at least one condition of the user equipment.

9. The apparatus of claim 8, wherein the at least one condition of the user equipment comprises one or more of:
a battery state of the user equipment;
a power state of the user equipment;
a radio resource control (RRC) state of the user equipment;
an active bandwidth part of the user equipment;
a condition of a channel between the user equipment and the network; or
a mobility state of the user equipment.

10. The apparatus of claim 1, wherein receiving the first machine learning model from the network according to at least one of the first configuration or the second configuration based on the determining comprises receiving the first machine learning model via one or more system information blocks (SIBs).

11. The apparatus of claim 1, wherein the control information comprises downlink control information (DCI) received via a physical downlink control channel (PDCCH).

12. The apparatus of claim 11, wherein the DCI comprises a bitmap or a codepoint configured to indicate a scheduled downlink message for receiving the first machine learning model.

13. The apparatus of claim 11, wherein the DCI includes a cyclic redundancy check (CRC) scrambled via a cell-specific or user equipment group-specific radio network temporary identifier (RNTI).

14. The apparatus of claim 1, wherein the control information comprises one or more medium access control (MAC) control elements (CEs).

15. The apparatus of claim 14, wherein downlink control information (DCI) scheduling the one or more MAC CEs includes a cyclic redundancy check (CRC) scrambled via a cell-specific or user equipment group-specific radio network temporary identifier (RNTI).

16. The apparatus of claim 1, wherein the control information comprises a radio resource control (RRC) message.

17. The apparatus of claim 16, wherein downlink control information (DCI) scheduling the RRC message includes a cyclic redundancy check (CRC) scrambled via a cell-specific or user equipment group-specific radio network temporary identifier (RNTI).

18. The apparatus of claim 1, wherein the control information comprises one or more system information blocks (SIBs).

19. The apparatus of claim 18, wherein downlink control information (DCI) scheduling the one or more SIBs includes a cyclic redundancy check (CRC) scrambled via a cell-specific or user equipment group-specific radio network temporary identifier (RNTI).

20. An apparatus for wireless communications at a network entity, comprising at least one memory comprising computer-executable instructions; and one or more processors configured to execute the computer-executable instructions and cause the apparatus to:
control information for a user equipment, wherein:
the control information indicates a first configuration for receiving a first type of machine learning model and a second configuration for receiving a second type of machine learning model,
the first type of machine learning model is configured for a first type of user equipment, and
the second type of machine learning model is configured for a second type of user equipment;
transmit a first machine learning model of the first type according to the first configuration; and
transmit a second machine learning model of the second type according to the second configuration.

21. The apparatus of claim 20, wherein the first type of machine learning model results in a lower complexity machine learning operation than the second type of machine learning model.

22. The apparatus of claim 21, wherein the first type of user equipment is a reduced capability user equipment and the second type of user equipment is a regular capability user equipment.

23. The apparatus of claim 22, wherein:
the first configuration schedules a first scheduled downlink message, and
the second configuration schedules a second scheduled downlink message.

24. The apparatus of claim 20, wherein transmitting the first machine learning model of the first type according to the first configuration comprises transmitting the first machine learning model via one or more system information blocks (SIBs).

25. The apparatus of claim 20, wherein the control information comprises at least one of downlink control information (DCI), one or more medium access control (MAC) control elements (CEs), a radio resource control (RRC) message, or one or more system information blocks (SIBs).

26. The apparatus of claim 25, wherein the control information comprises a bitmap or a codepoint configured to indicate a scheduled downlink message for receiving the first machine learning model.

27. The apparatus of claim 25, wherein the control information includes a cyclic redundancy check (CRC) scrambled via a cell-specific or user equipment group-specific radio network temporary identifier (RNTI).

28. (canceled)

29. (canceled)

30. A method, comprising:
receiving, at a user equipment from a network, control information, wherein:
the control information indicates a first configuration for receiving a first type of machine learning model and a second configuration for receiving a second type of machine learning model,
the first type of machine learning model is configured for a first type of user equipment, and
the second type of machine learning model is configured for a second type of user equipment;
determining to apply at least one of the first configuration or the second configuration based on whether the user equipment is the first type of user equipment or the second type of user equipment; and
receiving a first machine learning model from the network according to at least one of the first configuration or the second configuration based on the determining.

31. A method, comprising:
transmitting, from a network to a user equipment, control information, wherein:
the control information indicates a first configuration for receiving a first type of machine learning model and a second configuration for receiving a second type of machine learning model,
the first type of machine learning model is configured for a first type of user equipment, and
the second type of machine learning model is configured for a second type of user equipment;
transmitting a first machine learning model of the first type according to the first configuration; and
transmitting a second machine learning model of the second type according to the second configuration.
